(19) United States
(12) Patent Application Publication
(10) Pub. No.: US 2007/0280332 A1
(43) Pub. Date: Dec. 6, 2007

(54) Systems and Techniques for Radio Frequency Environment Awareness and Adaptation

(76) Inventors: Srikathyayani Srikanteswara, Hillsboro, OR (US); Christian Maciocco, Portland, OR (US); Hua Yang, Beaverton, OR (US); Xingang Guo, Portland, OR (US)

Correspondence Address: KACVINSKY LLC;C/O INTELLEVATE, P.O. BOX 52050, MINNEAPOLIS, MN, 55402, US

(21) Appl. No.: 11/618,745

(22) Filed: Dec. 30, 2006

Related U.S. Application Data
(60) Provisional application No. 60/811,175, filed on Jun. 5, 2006.

(51) Int. Cl. H04B 1/00

(52) U.S. Cl. 375/130; 375/E01.001

(57) ABSTRACT

Various embodiments directed to a radio frequency (RF) environment aware wireless communication device to analyze interference characteristics of at least one interferer in the presence of interference in an RF communications channel and to selectively perform one or more adaptation mechanisms for adjusting properties of a communications protocol based on the interference characteristics of the at least one interferer. The interferer may comprise a non-communicating device (e.g., microwave oven) or a communicating device (e.g., baby monitor, cordless phones, Bluetooth device, etc.) operating within or in the vicinity of a wireless network. The adaptation mechanisms may comprise contention window control to backoff and defer transmission according to a contention window and to leave a backoff counter of the contention window unchanged if the interference is determined to be non-802.11 interference. The adaptation mechanisms may comprise aggressive transmission to transmit over the interference. Other embodiments are described and claimed.

This application claims priority to U.S. Provisional Patent Application Ser. No. 60/811,175, which was filed on Jun. 5, 2006 and is incorporated by reference.

### BACKGROUND

Various types of wireless networks such as networks based on the Institute of Electrical and Electronics Engineers (IEEE) 802 standards including the IEEE 802.11 standards for Wireless Local Area Networks (WLANs), the IEEE 802.15 standards for Wireless Personal Area Networks (WPANs), and the IEEE 802.16 standards for WLANs and Wireless Metropolitan Area Networks (WMANs) are emerging as promising technologies to provide flexible and reliable network access in home, office and public environments. For each of these networks, alleviating and coping with the interference and impact from other co-existing devices is becoming a pressing concern.

The IEEE 802.11 air interface defines back off strategies for an 802.11 wireless communications device when in the presence of other co-existing devices. In particular, Carrier Sense Multiple Access (CSMA) back off algorithms of IEEE 802.11 air interfaces specify that 802.11 wireless communications devices are to back off and defer transmission in the presence of energy observed in a communications channel. The CSMA back off algorithms of IEEE 802.11 air interfaces assume that the back off is done in the presence of other 802.11 devices, and that all devices comply with the protocol.

Unlicensed frequency bands such as the Industrial Scientific and Medical (ISM) 2.4 GHz frequency band, however, have numerous devices operating in the same radio frequency (RF) spectrum, including both non-communicating devices (e.g., microwave ovens) and communicating devices (e.g., baby monitors, cordless phones, Bluetooth devices, etc.). Current implementations of the wireless network interface card (NIC) cause 802.11 wireless communications devices to back off in the presence of energy from any of these devices, thus hurting the performance of the WLAN network unnecessarily.

### BRIEF DESCRIPTION OF THE DRAWINGS

FIG. 1 illustrates a communications system in accordance with one or more embodiments.

FIG. 2 illustrates a logic flow for RF environment awareness and adaptation in accordance with one or more embodiments.

FIG. 3 illustrates a logic flow for contention window control (CWC) in accordance with one or more embodiments.

FIG. 4 illustrates a logic flow for aggressive transmission in accordance with one or more embodiments.

FIG. 5 illustrates a graphical representation showing transmission improvement achieved by implementing CWC in accordance with one or more embodiments.

FIG. 6 illustrates a graphical representation showing throughput improvement achieved by implementing CWC in accordance with one or more embodiments.

FIG. 7 illustrates a graphical representation showing throughput improvement achieved by implementing aggressive transmission in accordance with one or more embodiments.

FIG. 8 illustrates an article of manufacture comprising RF environment awareness and adaptation logic in accordance with one or more embodiments.

### DETAILED DESCRIPTION

Various embodiments directed to a radio frequency (RF) environment aware wireless communication device to analyze interference characteristics of at least one interferer in the presence of interference in an RF communications channel and to selectively perform one or more adaptation mechanisms for adjusting properties of a communications protocol based on the interference characteristics of the at least one interferer. The interferer may comprise a non-communicating device (e.g., microwave oven) or a communicating device (e.g., baby monitor, cordless phones, Bluetooth device, etc.) operating within or in the vicinity of a wireless network. The adaptation mechanisms may comprise contention window control to backoff and defer transmission according to a contention window and to leave a backoff counter of the contention window unchanged if the interference is determined to be non-802.11 interference. The adaptation mechanisms may comprise aggressive transmission to transmit over the interference. Other embodiments are described and claimed.

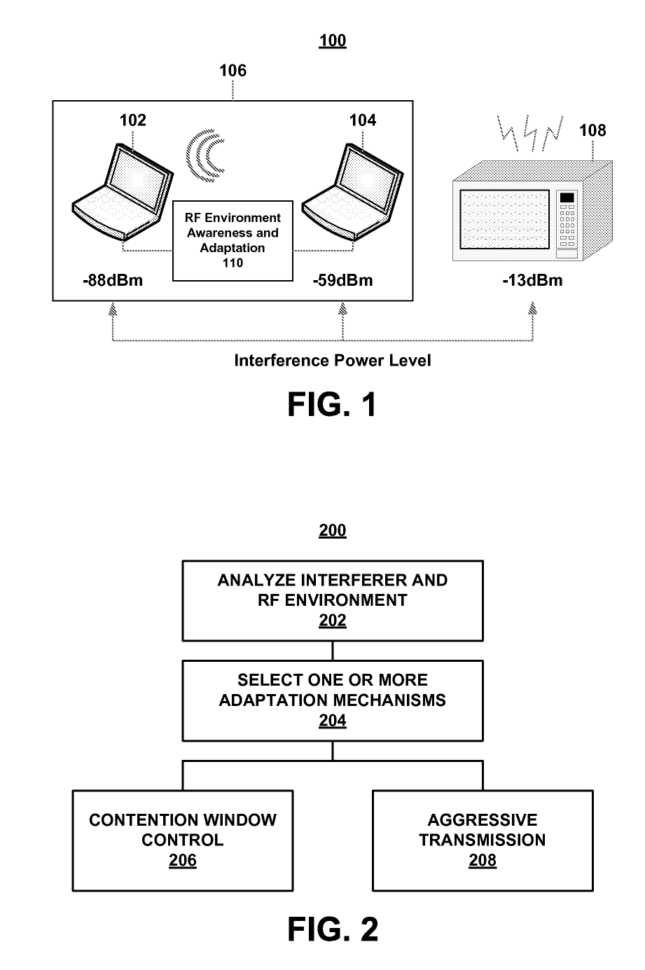

FIG. 1 illustrates a block diagram of one embodiment of a communications system 100. In various embodiments, the communications system 100 may comprise multiple nodes. A node generally may comprise any physical or logical entity for communicating information in the communications system 100 and may be implemented as hardware, software, or any combination thereof, as desired for a given set of design parameters or performance constraints. Although FIG. 1 may show a limited number of nodes by way of example, it can be appreciated that more or less nodes may be employed for a given implementation.

The nodes of the communications system 100 may be arranged to communicate one or more types of information, such as media information and control information. Media information generally may refer to any data representing content meant for a user, such as image information, video information, graphical information, audio information, voice information, textual information, numerical information, alphanumeric symbols, character symbols, and so forth. Control information generally may refer to any data representing commands, instructions or control words meant for an automated system. For example, control information may be used to route media information through a system, or instruct a node to process the media information in a certain manner. The media and control information may be communicated from and to a number of different devices or networks.

In various embodiments, the communications system 100 may comprise, or form part of a wired communications system, a wireless communications system, or a combination of both. For example, the communications system 100 may include one or more nodes arranged to communicate information over one or more types of wired communication links. Examples of a wired communication link, may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The communications system 100 also may include one or more nodes arranged to communicate information over one or more types of wireless communication links. Examples of a wireless communication link may include, without limitation, a radio channel, infrared channel, radio-frequency (RF) channel, Wireless Fidelity (WiFi) channel, a portion of the RF spectrum, and/or one or more licensed or license-free frequency bands.

The communications system 100 may communicate information in accordance with one or more standards as promulgated by a standards organization, such as the ITU, the ISO, the IEC, the IEEE, the IETF, and so forth. In one or more embodiments, for example, the communications system 100 may communicate information according to various IEEE 802 standards including IEEE 802.11 standards for WLANs such as the IEEE 802.11 standard (1999 Edition, Information Technology Telecommunications and Information Exchange Between Systems—Local and Metropolitan Area Networks—Specific Requirements, Part 11: WLAN Medium Access Control (MAC) and Physical (PHY) Layer Specifications), its progeny and supplements thereto (e.g., 802.11a, b, g/h, j, n, and variants).

In one or more embodiments, the communications system 100 may communicate information according to IEEE 802.15 standards for WPANs including: the IEEE 802.15.1-2005 standard (IEEE Standard for Information technology—Telecommunications and information exchange between systems—Local and metropolitan area networks—Specific requirements Part 15.1: Wireless medium access control (MAC) and physical layer (PHY) specifications for wireless personal area networks (WPANs)); the IEEE 802.15.2-2003 standard (IEEE Recommended Practice for Telecommunications and Information exchange between systems—Local and metropolitan area networks Specific Requirements—Part 15.2: Coexistence of Wireless Personal Area Networks with Other Wireless Devices Operating in Unlicensed Frequency Bands); the IEEE 802.15.3-2003 standard (IEEE Standard for Information technology—Telecommunications and information exchange between systems—Local and metropolitan area networks—Specific requirements Part 15.3: Wireless Medium Access Control (MAC) and Physical Layer (PHY) Specifications for High Rate Wireless Personal Area Networks (WPAN)); the IEEE Std 802.15.3b™-2005 standard (Amendment to IEEE Std 802.15.3-2003, IEEE Standard for Information technology—Telecommunications and information exchange between systems—Local and metropolitan area networks—Specific requirements Part 15.3: Wireless Medium Access Control (MAC) and Physical Layer (PHY) Specifications for High Rate Wireless Personal Area Networks (WPANS) Amendment 1: MAC Sublayer); the IEEE 802.15.4-2003 standard (IEEE Standard for Information technology—Telecommunications and information exchange between systems—Local and metropolitan area networks—Specific requirements Part 15.4: Wireless Medium Access Control (MAC) and Physical Layer (PHY) Specifications for Low Rate Wireless Personal Area Networks (LR-WPANs)); their progeny and supplements thereto.

In one or more embodiments, the communications system 100 may communicate information according to IEEE 802.16 standards for WMANs including the IEEE 802.16 standard (IEEE Std 802.16-2001 for Local and Metropolitan area networks Part 16: Air Interface for Fixed Broadband Wireless Access Systems); its progeny and supplements thereto (e.g., 802.16-2004, 802.16.2-2004, 802.16e, 802.16f, and variants).

Although some embodiments may be described with the communications system 100 being based on one more IEEE 802.11, 802.15, and/or 802.16 standards for purposes of illustration, it can be appreciated that the embodiments are not limited in this context. For example, the communications system 100 may communicate information according to IEEE 802.19, 802.22 standards, and/or any other wireless communications standard which is consistent with the described embodiments.

The communications system 100 may communicate, manage, or process information in accordance with one or more protocols. A protocol may comprise a set of predefined rules or instructions for managing communication among nodes. In various embodiments, for example, the communications system 100 may employ one or more protocols such as medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), and so forth.

As shown in FIG. 1, the communications system 100 may comprise a sender node 102 coupled to a receiver node 104. In various embodiments, the sender node 102 and the receiver node 104 may be implemented as wireless devices. Examples of wireless devices may include, without limitation, a wireless access point (AP), a wireless client device, a wireless station (STA), a laptop computer, ultra-laptop computer, portable computer, personal computer (PC), notebook PC, handheld computer, personal digital assistant (PDA), cellular telephone, combination cellular telephone/PDA, smart phone, pager, messaging device, media player, digital music player, set-top box (STB), appliance, subscriber station, workstation, user terminal, mobile unit, and so forth. In such embodiments, the sender node 102 and the receiver node 104 may comprise one more wireless interfaces and/or components for wireless communication such as one or more transmitters, receivers, transceivers, chipsets, amplifiers, filters, control logic, network interface cards (NICs), antennas, and so forth. Examples of an antenna may include, without limitation, an internal antenna, an omni-directional antenna, a monopole antenna, a dipole antenna, an end fed antenna, a circularly polarized antenna, a micro-strip antenna, a diversity antenna, a dual antenna, an antenna array, and so forth.

The sender node 102 and the receiver node 104 may comprise or form part of a wireless network 106. In various embodiments, the wireless network 106 may comprise a wireless local area network (WLAN) such as a basic service set (BSS) and/or extended service set (ESS) wireless network configured to communicate information in accordance with IEEE 802.11 and/or 802.16 standards for WLANs and to implement an associated protocol. In one or more embodiments, the wireless network 106 may comprise an 802.11g WLAN, and the sender node 102 may comprise an access point (AP) communicatively coupled to a receiver node 104 comprising a wireless client or STA.

Although some embodiments may be described with the wireless network 106 implemented as a WLAN for purposes of illustration, the embodiments are not limited in this context. For example, the wireless network 106 may comprise or be implemented as various types of wireless networks and associated protocols such as a WMAN, a WPAN, a Wireless Wide Area Network (WWAN), a Worldwide Interoperability for Microwave Access (WiMAX) network, a Broadband Wireless Access (BWA) network, a radio network, a television network, a satellite network such as a direct broadcast satellite (DBS) network, and/or any other wireless communications network which is consistent with the described embodiments.

In various embodiments, the sender node 102 and/or the receiver node 104 may operate in the presence of at least one interferer 108. The interferer 108 may comprise, for example, a non-communicating device (e.g., microwave oven) or a communicating device (e.g., baby monitor, cordless phones, Bluetooth device, etc.) operating within or in the vicinity of the wireless network 106. The interferer 108 may emit energy resulting in interference to the sender node 102, the receiver node 108, or both. The interferer 108 may operate in the same RF spectrum as the sender node 102 and the receiver node 104 and may emit energy into an RF channel used for communication between the sender node 102 and the receiver node 104. In some cases, the interferer 108 may operate in an unlicensed frequency band such as the ISM 2.4 GHz or 5 GHz frequency band.

In one or more embodiments, the interferer 108 may comprise a microwave oven. In such embodiments, the microwave oven may emit energy in the ISM 2.4 GHz frequency band, for example. While on, the microwave oven may emit energy periodically rather than continuously. For example, the microwave oven may be synchronized with an alternating current (AC) main power supply (e.g., 60 Hz or 50 Hz) and periodically emit energy only during certain intervals (e.g., 8 ms intervals). In some cases, the amount energy emitted by the microwave oven may be comparable to or greater than that of a typical WLAN device. Because the microwave oven is not a communications device and does not adhere to any communications protocol, the microwave oven may behave like a rogue transmitter and interfere with one or more communications devices (e.g., sender node 102 and/or receiver node 104) within its vicinity.

FIG. 1 illustrates varying interference powers levels in the wireless network 106 (e.g., 802.11a/b/g/n network). It can be appreciated that while one sender node 102, one receiver node 104, and one interferer 108 are shown for purposes of illustration, the communications system 100 may comprise any number of nodes (e.g., sender nodes, receiver nodes) and interferers consistent with the described embodiments. For example, different levels of interference may be detected by different devices located in different levels of a home or office.

For purposes of illustration and not limitation, in this embodiment, the receiver node 104 detects the interference generated by the interferer 108 (e.g., microwave oven), and the sender node 102 does not. When the sender node 102 does not receive 801.11 MAC level acknowledgement (ACK) packets from the receiver node 104, the sender node 102 assumes that the packet has been lost due to congestion not interference. Congestion is when there are too many WLAN devices in the network all trying to transmit. In other words, congestion is specifically from WLAN signals.

Conventional 802.11 wireless communications devices are configured to backoff and defer transmission in the presence of energy observed in a communications channel. In particular, CSMA back off algorithms of IEEE 802.11 air interfaces specify that 802.11 devices are to back off (stop transmitting) and defer a subsequent transmission attempt for the duration of a contention window. When the contention window ends, the 802.11 device may attempt another transmission. If the transmission is successful, the backoff and deference concludes. If the transmission is unsuccessful, however, the contention window is increased (e.g., CW=CW*2+1) before another transmission attempt can be made.

Conventional CSMA backoff algorithms assume that backoff and deference is done in the presence of other 802.11 devices, and that all devices comply with the protocol. Since the CSMA backoff algorithms make no distinction between 802.11 transmissions and other transmissions, conventional 802.11 devices backoff in the presence of any observed energy in the communications channel which leads to wasted slots and drop in throughput.

For example, a microwave oven in the vicinity of an 802.11 WLAN may cause an 802.11 communications device to backoff and defer transmission. If the 802.11 device attempts retransmission one or more times while the microwave oven is on, the contention window parameter for the 802.11 device will keep doubling every time transmission is unsuccessful. As a result, the 802.11 device will wait longer and longer before making the next retransmission attempt. Even when the microwave oven completes and stops emitting energy, the 802.11 device may be forced to defer retransmission and spend time running down its backoff counter. Once the device starts transmitting, it might hit the next on period of the microwave. Under these conditions, the available transmit time slots are not being fully utilized resulting in reduced throughput.

As illustrated in FIG. 1, the communications system 100 may comprise an RF environment awareness and adaptation module 110. The RF environment awareness and adaptation module 110 may be implemented by one or more chips or integrated circuits (ICs) and may comprise, for example, hardware and/or software such as logic (e.g., instructions, data, and/or code) to be executed by a logic device. Examples of a logic device include, without limitation, a central processing unit (CPU), microcontroller, microprocessor, general purpose processor, dedicated processor, chip multiprocessor (CMP), media processor, digital signal processor (DSP), network processor, coprocessor, input/output (I/O) processor, application specific integrated circuit (ASIC), field programmable gate array (FPGA), programmable logic device (PLD), and so forth. Executable logic may be stored internally or externally to a logic device on one or more types of computer-readable storage media such as volatile or non-volatile memory, removable or non-removable memory, erasable or non-erasable memory, writeable or re-writeable memory, and so forth. The RF environment awareness and adaptation module 110 module may comprise components which are physically or logically coupled and/or connected by communications media comprising wired communication media, wireless communication media, or a combination of both, as desired for a given implementation.

In various embodiments, the RF environment awareness and adaptation module 110 may be implemented by at least one of the sender node 102 and the receiver node 104. In some embodiments, the sender node 102 and the receiver node 104 may cooperatively implement various aspects of the RF environment awareness and adaptation module 110. In other embodiments, the RF environment awareness and adaptation module 110 may be implemented by either the sender node 102 or the receiver node 104.

The RF environment awareness and adaptation module 110 may be arranged to analyze interference characteristics of the interferer 108 and to selectively perform one or more adaptation mechanisms for adjusting properties of a communications protocol based on the interference characteristics of the at least one interferer. In some embodiments, the adaptation mechanisms may comprise contention window control (CWC) to backoff and defer transmission according to a contention window and to leave a backoff counter of the contention window unchanged if the interference is determined to be non-802.11 interference. The adaptation mechanisms also may comprise aggressive transmission to transmit over the interference

In one or more embodiments, the RF environment awareness and adaptation module 110 may be implemented by the MAC layer of a wireless interface and/or component in the sender node 102 and/or receiver node 104. In such embodiments, the RF environment awareness and adaptation module 110 may be implemented as a feature in the MAC layer of the communication protocol stack within a NIC, transceiver, and/or wireless communication chipset of a wireless device. While the one or more adaptation mechanism may be implemented at the MAC layer, it can be appreciated that the embodiments are not limited in this context. For example, in one or more embodiments, the adaptation mechanisms may be implemented by various layers (e.g., MAC layer and/or PHY layer) to achieve cross-layer optimization.

FIG. 2 illustrates a logic flow 200 for RF environment awareness and adaptation in accordance with one or more embodiments. The logic flow 200 may be performed by various systems, nodes, devices, and/or components and may be implemented as hardware, software, and/or any combination thereof, as desired for a given set of design parameters or performance constraints. For example, the logic flow 200 may be implemented by one or more logic devices and/or logic comprising instructions, data, and/or code to be executed by a logic device. In various embodiments, the logic flow 200 may be implemented by one or more elements of the communications system 100 illustrated in FIG. 1 such as the sender node 102 and/or the receiver node 104 of the wireless network 106. The embodiments, however, are not limited in this context.

The logic flow 200 may comprise analyzing interferer and RF environment (block 202). In one or more embodiments, a wireless communications device may detect the presence of interference in an RF environment caused by at least one interferer 108. The interferer 108 may comprise, for example, non-communicating devices (e.g., microwave ovens) and/or communicating devices (e.g., baby monitors, cordless phones, Bluetooth devices, etc.). The wireless communications device may be implemented as a transmitting device (e.g., sender node 102) and/or a receiving device (e.g., receiver node 104). In some cases, a receiving device may convey detected interference information to a transmitting device. In other cases, the transmitting device itself may detect the interference.

In various embodiments, the interferer 108 may operate in the same RF spectrum and/or frequency band as the wireless communications device (e.g., sender node 102 and/or receiver node 104) and may emit energy into a communications channel of the wireless communications device. In some cases, the interferer device may be operating in an unlicensed frequency band such as the ISM 2.4 GHz or 5 GHz frequency band.

In various implementations, one or more wireless communications devices (e.g., sender node 102 and/or receiver node 104) may perform spectrum sensing to detect certain interference characteristics or parameters. The interference characteristics or parameters may be used to characterize the communications channel and may comprise, for example, type, periodicity, energy level, and so forth. A wireless communications device may be arranged to operate according to a certain protocol (e.g., 802.11 communications protocol) and to differentiate among devices which are not operating according to the protocol. For example, an 802.11 b/g device may be arranged to differentiate 802.11 b/g devices from non-802.11 b/g devices based on the output of the spectrum sensing.

The wireless network 106 (e.g., 802.11 b/g network) may be arranged to operate in infrastructure, ad-hoc, or peer-to-peer mode. Accordingly, the interference characteristics or parameters may be exchanged between AP and STA devices, client and server devices, as well as among multiple client devices or STAs communicating within the wireless network 106. This may enhance the overall performance of the wireless network 106 in the event that some network devices are unable to directly sense the interference.

The logic flow 200 may comprise selecting one or more adaptation mechanisms (block 204). In various embodiments, a wireless communications device (e.g., sender node 102 and/or receiver node 104) may be arranged to selectively implement one or more adaptation mechanisms to maintain high performance in the presence of a detected interferer. The adaptation mechanisms may comprise one or more interference avoidance and/or mitigation techniques based on the knowledge of interferer characteristics and the RF environment. From such knowledge, an RF environment aware wireless communications device (e.g., 802.11 device) may be configured to take appropriate actions for improving and/or maximizing its network throughput performance by compensating for the channel interference caused by the detected interferer.

The adaptation mechanisms may be configured to adjust various parameters and properties of a wireless communications device based on the interferer characteristics and the RF environment. In various embodiments, the adaptation mechanisms may adjust protocol level properties to adapt device operation to RF channel conditions and enhance device performance.

In one or more embodiments, the adaptation mechanisms may be implemented by the MAC layer of the wireless communications device. In such embodiments, the adaptation mechanisms may be configured to adjust various MAC level protocol parameters and properties to adapt device operation to RF channel conditions. The wireless communications device may comprise an Environment Aware MAC (EAM) device arranged to select one (e.g., most appropriate) or more MAC protocol adaptation mechanisms to enhance performance.

While the one or more adaptation mechanism may be implemented at the MAC layer, it can be appreciated that the embodiments are not limited in this context. For example, in one or more embodiments, the adaptation mechanisms may be implemented by various layers (e.g., MAC layer and/or PHY layer) to achieve cross-layer optimization.

The logic flow 200 may comprise performing contention window control (block 206). In one or more embodiments, a wireless communications device (e.g., 802.11 device) may be configured to backoff and defer transmission in the presence of detected interference observed in a communications channel. For example, the wireless communications device may be arranged to backoff (stop transmitting) and defer a subsequent transmission attempt for the duration of a contention window. When the contention window ends, the wireless communications device may attempt another transmission.

If the transmission is unsuccessful, the wireless communications device may be arranged to determine whether the detected interference is from a non-802.11 device (e.g., microwave oven, baby monitor, cordless phones, Bluetooth device, etc.). If the interference is determined to be 802.11 interference, the contention window is increased (e.g., CW=CW*2+1). If the detected interference is determined to be non-802.11 interference, however, the CWC may implement intelligent control of the contention window backoff counter. For example, the backoff counter of the contention window may be left unchanged in the presence of non-802.11 interference and transmission may be performed. In some cases, if the non-802.11 interference is periodic (e.g., microwave oven interference), the data may be transmitted during silent periods of the duty cycle of the interfering device.

In various implementations, the intelligent backoff CWC may ensure that 802.11 wireless communications devices (e.g., STAs) double their contention window size only based on other 802.11 traffic. Accordingly, transmit opportunities may be fully utilized and overall throughput may be improved.

The logic flow 200 may comprise performing aggressive transmission (block 208). In one or more embodiments, aggressive transmission may comprise detecting the presence of interference caused by a non-communicating device such as a microwave oven. The interference may be detected by a wireless device implemented as a transmitting device (e.g., sender node 102) and/or a receiving device (e.g., receiver node 104). In some cases, a receiving device may convey detected interference information to a transmitting device. In other cases, the transmitting device itself may detect the interference.

The aggressive transmission may be based on SNR and may comprise increasing the CCA threshold of the transmitting device if sufficient SNR is available. In general, a wireless communication device may be prevented from transmitting if the observed energy exceeds the clear channel assessment (CCA) threshold. The CCA threshold may be increased such that the wireless communication device (e.g., sender node 102) is capable of transmitting over the detected interference.

In some embodiments, the transmitting device (e.g., sender node 102) may select an appropriate modulation rate based on the RF environment of a receiving device (e.g., receiver node 102). The modulation rate for transmission may be selected based on the SNR estimated by the receiving device. For example, if only the receiving device detects the interference, the receiving device may estimate the interference power and convey such information to the transmitting device. The transmitting device may then select the appropriate modulation rate (e.g., lower modulation rate) based on the RF environment of the receiving device.

The aggressive transmission may comprise transmitting over the detected interference. In one or more embodiments, the transmitting device (e.g., sender node 102) may be arranged to transmit or “scream over” the detected interference by increasing the CCA threshold.

In various implementations, the SNR based aggressive transmission may be useful especially when non-communicating devices such as microwave ovens are present in the RF environment. The aggressive transmission is applicable in cases where other wireless LAN devices co-exist or not. In some embodiments, aggressive transmission may be used in conjunction with CWC to enhance performance.

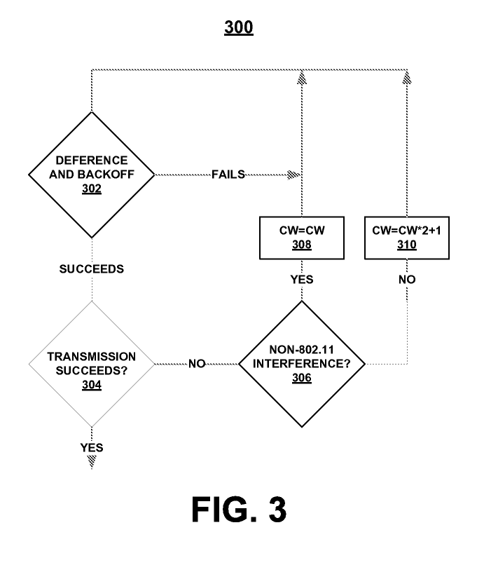

FIG. 3 illustrates a logic flow 300 for CWC in accordance with one or more embodiments. The logic flow 300 may be performed by various systems, nodes, devices, and/or components and may be implemented as hardware, software, and/or any combination thereof, as desired for a given set of design parameters or performance constraints. For example, the logic flow 300 may be implemented by one or more logic devices and/or logic comprising instructions, data, and/or code to be executed by a logic device. In various embodiments, the logic flow 300 may be implemented by one or more elements of the communications system 100 illustrated in FIG. 1 such as the sender node 102 and/or the receiver node 104 of the wireless network 106. The embodiments, however, are not limited in this context.

The logic flow 300 may comprise performing deference and backoff (block 302). In one or more embodiments, an 802.11 wireless communications device may be configured to backoff and defer transmission in the presence of detected interference observed in a communications channel. The 802.11 device may be arranged to backoff (stop transmitting) and defer a subsequent transmission attempt for the duration of a contention window. When the contention window ends, the 802.11 device may attempt another transmission.

The logic flow 300 may comprise determining whether the transmission succeeds (block 304). If the transmission succeeds, the logic flow 300 concludes. If the transmission is unsuccessful, it is determined whether the detected interference is non-802.11 interference (block 306).

If the detected interference is determined to be non-802.11 interference, the contention window is left unchanged (block 308). In various embodiments, if interference from a non-802.11 device (e.g., microwave oven, baby monitor, cordless phones, Bluetooth device, etc.) was present during the unsuccessful transmission of a packet, the contention window is not doubled and the packet is transmitted. In some cases, if the non-802.11 interference is periodic (e.g., microwave oven interference), the data may be transmitted during silent periods of the duty cycle of the interfering device.

If the interference is determined to be 802.11 interference, the contention window is increased (e.g., CW=CW*2+1) (block 310) before the process is repeated and another transmission attempt can be made.

In various embodiments, the logic flow 300 may implement an intelligent backoff CWC mechanism that ensures that 802.11 wireless communications devices (e.g., STAs) double their contention window size only based on other 802.11 traffic. Accordingly, transmit opportunities may be fully utilized and overall throughput may be improved.

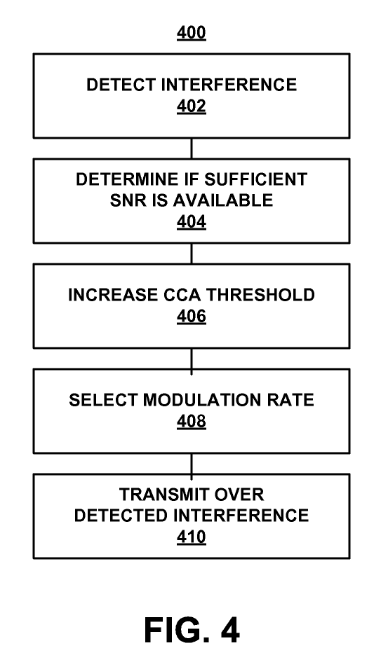

FIG. 4 illustrates a logic flow 400 for aggressive transmission in accordance with one or more embodiments. The logic flow 400 may be performed by various systems, nodes, devices, and/or components and may be implemented as hardware, software, and/or any combination thereof, as desired for a given set of design parameters or performance constraints. For example, the logic flow 400 may be implemented by one or more logic devices and/or logic comprising instructions, data, and/or code to be executed by a logic device. In various embodiments, the logic flow 400 may be implemented by one or more elements of the communications system 100 illustrated in FIG. 1 such as the sender node 102 and/or the receiver node 104 of the wireless network 106. The embodiments, however, are not limited in this context.

The logic flow 400 may comprise detecting interference (block 402). In one or more embodiments, a wireless communications device may detect the presence of interference caused by a non-communicating device such as a microwave oven. The wireless device may be implemented as a transmitting device (e.g., sender node 102) and/or a receiving device (e.g., receiver node 104). In some cases, a receiving device may convey detected interference information to a transmitting device. In other cases, the transmitting device itself may detect the interference.

The logic flow 400 may comprise determining if sufficient SNR is available (block 404) and increasing the CCA threshold if sufficient SNR is available (block 406). In general, a wireless communication device may be prevented from transmitting if the observed energy exceeds the clear channel assessment (CCA) threshold. In various embodiments, the CCA threshold is increased such that the wireless communication device is capable of transmitting over the detected interference.

The logic flow 400 may comprise selecting a modulation rate based on the RF environment of a receiving device (block 408). In one or more embodiments, the transmission modulation rate may be selected based on the SNR estimated by a receiving device. For example, if only the receiving device detects interference from the microwave oven, the receiving device may estimate the interference power and convey interference information to the transmitting device. The transmitting device may select the appropriate modulation rate based on the RF environment of the receiving device. In some cases, for example, it may be necessary to lower the modulation rate depending upon the strength of the interference generated by the microwave oven.

The logic flow 400 may comprise transmitting over the detected interference (block 410). In one or more embodiments, the transmitting device may transmit or “scream over” the detected interference by increasing the CCA threshold. The SNR based aggressive transmission mechanism is useful especially when non-communicating devices such as microwave ovens are present in the RF environment. In some embodiments, aggressive transmission may be used in conjunction with CWC to enhance performance.

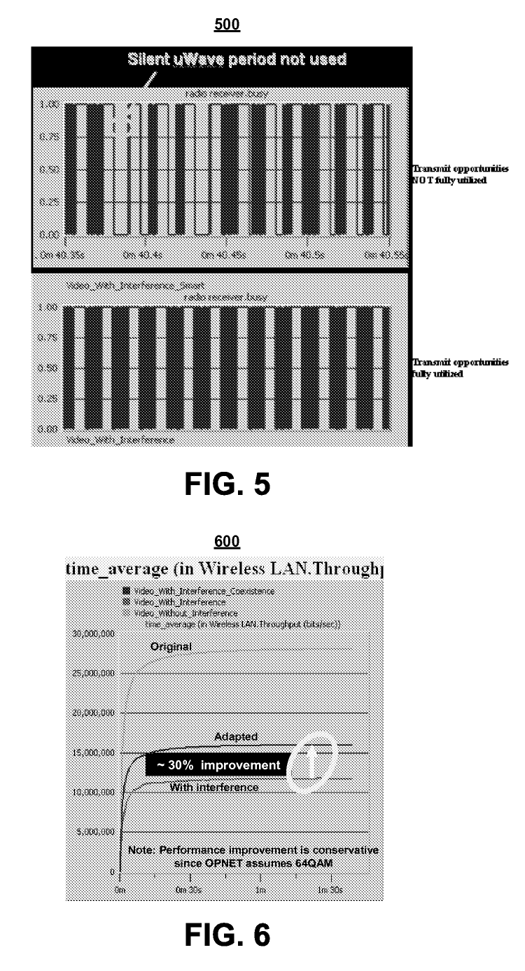

FIG. 5 illustrates a graphical representation 500 in accordance with one or more embodiments. The graphical representation 500 demonstrates transmission improvement achieved by implementing CWC in the presence of a 40% duty cycle microwave oven. The top graph illustrates conventional 802.11 backoff operation. As shown, periods in which the microwave is silent are not utilized for transmission. The lower graph illustrates intelligent synchronization with the on/off periods of the microwave oven to transmit during silent microwave periods. As shown, transmit opportunities may be fully utilized by implementing CWC to transmit significantly more data as compared to conventional techniques.

FIG. 6 illustrates a graphical representation 600 in accordance with one or more embodiments. The graphical representation 600 demonstrates throughput improvement achieved by implementing CWC in the presence of a microwave oven. As shown, improvement of approximately 20-30% may be achieved over conventional techniques which do not perform adaptation.

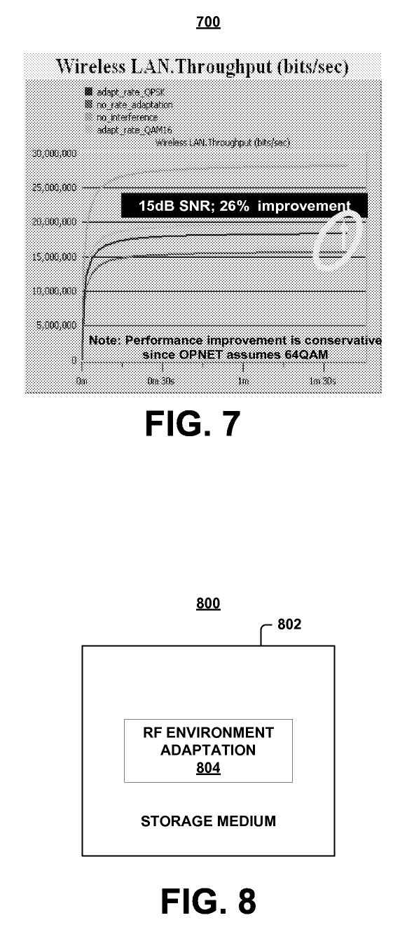

FIG. 7 illustrates a graphical representation 700 showing throughput improvement in accordance with one or more embodiments. The graphical representation 700 demonstrates throughput improvement achieved by implementing aggressive transmission in the presence of a microwave oven. As shown, a gain of approximately 26% may be achieved over conventional techniques.

FIG. 8 illustrates an article of manufacture 800 in accordance with one or more embodiments. As shown, the article 800 may comprise a storage medium 802 to store RF environment awareness and adaptation logic 804 for performing various operations in accordance with the described embodiments. In various embodiments, the article 800 may be implemented by various systems, components, and/or modules.

The article 800 and/or storage medium 802 may include one or more types of computer-readable storage media capable of storing data, including volatile memory or, non-volatile memory, removable or non-removable memory, erasable or non-erasable memory, writeable or re-writeable memory, and so forth. Examples of a computer-readable storage medium may include, without limitation, random-access memory (RAM), Dynamic RAM (DRAM), Synchronous DRAM (SDRAM), Double-Data-Rate RAM (DDR RAM), DDR SDRAM, static RAM (SRAM), read-only memory (ROM), programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other type of computer-readable storage media suitable for storing information.

The article 800 and/or storage medium 802 may store RF environment awareness and adaptation logic 804 comprising instructions, data, and/or code that, if executed, cause a system to perform a method and/or operations in accordance with the described embodiments. The computer or computer system may include, for example, any suitable computer, computer system, computing platform, computing device, computing system, processing platform, processing device, processing system, processor, and so forth, and may be implemented using any suitable hardware and/or software.

The RF environment awareness and adaptation logic 804 may comprise, or be implemented as, software, a software module, an application, a program, a subroutine, instructions, an instruction set, computing code, words, values, symbols or combination thereof. The instructions may include any suitable type of code, such as source code, compiled code, interpreted code, executable code, static code, dynamic code, and so forth. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

Various embodiments may comprise one or more elements. An element may comprise any structure arranged to perform certain operations. Each element may be implemented as hardware, software, or any combination thereof, as desired for a given set of design and/or performance constraints. Although an embodiment may be described with a limited number of elements in a certain topology by way of example, the embodiment may include more or less elements in alternate topologies as desired for a given implementation.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, API, exchanging messages, and so forth.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. An apparatus comprising:
a wireless communications device to analyze interference characteristics of at least one interferer in the presence of interference in a radio frequency communications channel, the wireless communications device to selectively perform one or more adaptation mechanisms for adjusting properties of a communications protocol based on the interference characteristics of the at least one interferer.

2. The apparatus of claim 1, the wireless communications device implemented as at least one of a transmitting device and a receiving device.

3. The apparatus of claim 1, the wireless communications device to perform spectrum sensing to detect the interference characteristics of the at least one interferer.

4. The apparatus of claim 1, the interference characteristics comprising one or more of type, periodicity, and energy level.

5. The apparatus of claim 1, the interferer comprising a non-communicating device.

6. The apparatus of claim 5, the non-communicating device comprising a microwave oven.

7. The apparatus of claim 1, the interferer comprising a communicating device.

8. The apparatus of claim 7, the communicating device comprising at least one of a baby monitor, a cordless phone, and a Bluetooth device.

9. The apparatus of claim 1, the wireless communications device comprising an 802.11 device, and the interferer comprising a non-802.11 device.

10. The apparatus of claim 1, the interferer operating in an unlicensed frequency band.

11. The apparatus of claim 1, the wireless communications device to differentiate among devices which do not operate according to the communications protocol.

12. The apparatus of claim 1, the wireless communications device to exchange interference characteristics with one or more network devices within a wireless network.

13. The apparatus of claim 12, the wireless network arranged to operate in at least one of an infrastructure, ad-hoc, and peer-to-peer mode.

14. The apparatus of claim 1, the adaptation mechanisms implemented by a Medium Access Control (MAC) layer of the wireless communications device.

15. The apparatus of claim 1, the adaptation mechanisms implemented by a Physical (PHY) physical layer of the wireless communications device.

16. The apparatus of claim 1, the adaptation mechanisms comprising contention window control to backoff and defer transmission according to a contention window and to leave a backoff counter of the contention window unchanged if the interference is determined to be non-802.11 interference.

17. The apparatus of claim 16, the contention window control to determine whether the interference is from a non-802.11 device in the event of an unsuccessful transmission.

18. The apparatus of claim 16, the contention window control to increase the backoff counter of the contention window if the interference is determined to be 802.11 interference.

19. The apparatus of claim 16, the contention window control to transmit during silent periods of a duty cycle of the interferer.

20. The apparatus of claim 1, the adaptation mechanisms comprising aggressive transmission to transmit over the interference.

21. The apparatus of claim 20, the aggressive transmission to detect interference caused by a non-communicating device.

22. The apparatus of claim 20, the aggressive transmission to increase a clear channel assessment (CCA) threshold if a sufficient signal-to-noise ration (SNR) is available.

23. The apparatus of claim 20, the aggressive transmission to select an appropriate modulation rate for transmission based on an RF environment of a receiving device.

24. The apparatus of claim 23, the modulation rate selected based on a SNR estimated by the receiving device.

25. A method comprising:
analyzing interference characteristics of at least one interferer in the presence of interference in a radio frequency communications channel; and
selectively performing one or more adaptation mechanisms for adjusting properties of a communications protocol based on the interference characteristics of the at least one interferer.

26. The method of claim 25, further comprising performing spectrum sensing to detect the interference characteristics of the at least one interferer.

27. The method of claim 25, further comprising differentiating among devices which do not operate according to the communications protocol.

28. The method of claim 25, the adaptation mechanisms implemented by a Medium Access Control (MAC) layer of a wireless communications device.

29. The method of claim 25, the adaptation mechanisms implemented by a Physical (PHY) physical layer of a wireless communications device.

30. The method of claim 25, further comprising performing contention window control to backoff and defer transmission according to a contention window and to leave a backoff counter of the contention window unchanged if the interference is determined to be non-802.11 interference.

31. The method of claim 30, further comprising determining whether the interference is from a non-802.11 device in the event of an unsuccessful transmission.

32. The method of claim 30, further comprising increasing the backoff counter of the contention window if the interference is determined to be 802.11 interference.

33. The method of claim 30, further comprising transmitting during silent periods of a duty cycle of the interferer.

34. The method of claim 25, further comprising performing aggressive transmission to transmit over the interference.

35. The method of claim 34, further comprising detecting interference caused by a non-communicating device.

36. The method of claim 34, further comprising increasing a clear channel assessment (CCA) threshold if a sufficient signal-to-noise ration (SNR) is available.

37. The method of claim 34, further comprising selecting an appropriate modulation rate for transmission based on an RF environment of a receiving device.

38. The method of claim 37, further comprising selecting the modulation rate based on a SNR estimated by the receiving device.

39. An article comprising a computer-readable storage medium containing instructions that if executed enable a system to:
analyze interference characteristics of at least one interferer in the presence of interference in a radio frequency communications channel; and
selectively perform one or more adaptation mechanisms for adjusting properties of a communications protocol based on the interference characteristics of the at least one interferer.

40. The article of claim 39, further comprising instructions that if executed enable the system to perform spectrum sensing to detect the interference characteristics of the at least one interferer.

41. The article of claim 39, further comprising instructions that if executed enable the system to differentiate among devices which do not operate according to the communications protocol.

42. The article of claim 39, the adaptation mechanisms implemented by a Medium Access Control (MAC) layer of a wireless communications device.

43. The article of claim 39, the adaptation mechanisms implemented by a Physical (PHY) physical layer of a wireless communications device.

44. The article of claim 39, further comprising instructions that if executed enable the system to perform contention window control to backoff and defer transmission according to a contention window and to leave a backoff counter of the contention window unchanged if the interference is determined to be non-802.11 interference.

45. The article of claim 44, further comprising instructions that if executed enable the system to determine whether the interference is from a non-802.11 device in the event of an unsuccessful transmission.

46. The article of claim 44, further comprising instructions that if executed enable the system to increase the backoff counter of the contention window if the interference is determined to be 802.11 interference.

47. The article of claim 44, further comprising instructions that if executed enable the system to transmit during silent periods of a duty cycle of the interferer.

48. The article of claim 39, further comprising instructions that if executed enable the system to perform aggressive transmission to transmit over the interference.

49. The article of claim 48, further comprising instructions that if executed enable the system to detect interference caused by a non-communicating device.

50. The article of claim 48, further comprising instructions that if executed enable the system to increase a clear channel assessment (CCA) threshold if a sufficient signal-to-noise ration (SNR) is available.

51. The article of claim 48, further comprising instructions that if executed enable the system to select an appropriate modulation rate for transmission based on an RF environment of a receiving device.

52. The article of claim 48, further comprising instructions that if executed enable the system to select the modulation rate based on a SNR estimated by the receiving device.

53. A system comprising:
an antenna; and
a wireless communications device to couple to the antenna, the wireless communications device comprising a radio frequency (RF) environment awareness and adaptation module to analyze interference characteristics of at least one interferer in the presence of interference in an RF communications channel and to selectively perform one or more adaptation mechanisms for adjusting properties of a communications protocol based on the interference characteristics of the at least one interferer.

54. The system of claim 53, the interferer comprising a non-communicating device.

55. The system of claim 54, the non-communicating device comprising a microwave oven.

56. The system of claim 53, the interferer comprising a communicating device.

57. The system of claim 56, the communicating device comprising at least one of a baby monitor, a cordless phone, and a Bluetooth device.

58. The system of claim 53, the wireless communications device comprising an 802.11 device, and the interferer comprising a non-802.11 device.

59. The system of claim 53, the adaptation mechanisms comprising contention window control to backoff and defer transmission according to a contention window and to leave a backoff counter of the contention window unchanged if the interference is determined to be non-802.11 interference.

60. The system of claim 53, the adaptation mechanisms comprising aggressive transmission to transmit over the interference.
